(19) United States
(12) Patent Application Publication
(10) Pub. No.: US 2018/0038087 A1
(43) Pub. Date: Feb. 8, 2018

(54) Blockage Prevention Device for Plumbing Vent Pipe

(71) Applicant: Jamie Waldner, Stonewall (CA)

(72) Inventor: Jamie Waldner, Stonewall (CA)

(21) Appl. No.: 15/667,853

(22) Filed: Aug. 3, 2017

Related U.S. Application Data
(60) Provisional application No. 62/370,396, filed on Aug. 3, 2016.

(51) Int. Cl. E03C 1/122; F16L 41/02; F15D 1/02; F16L 7/00

(52) U.S. Cl. CPC E03C 1/1222; F16L 7/00; F16L 41/021; F15D 1/02

(57) ABSTRACT

A blockage prevention device is releasably supported within a vent pipe of a plumbing system having an open top end which is externally vented through the roof of a building. The device has a hollow venting tube with an outer diameter which is less than an inner diameter of the vent pipe and a suspension element fixed to the venting tube having an overall width which is greater than the inner diameter of the vent pipe to suspend the venting tube within the vent pipe. The suspension element is spaced above the bottom end of the venting tube for engaging the top end of the vent pipe such that i) the bottom end of the venting tube is suspended within the vent pipe in open communication with the vent pipe, and ii) the top end of the venting tube communicates externally of the vent pipe.

This application claims the benefit under 35 U.S.C. 119(e) of U.S. provisional application Ser. No. 62/370,396, filed Aug. 3, 2016.

### FIELD OF THE INVENTION

The present invention relates to a blockage prevention device for preventing a blockage, for example a frost build-up, within the vent pipe of a plumbing system, and more particularly the present invention relates to a blockage prevention device comprising a hollow tube suspended within the top end of the plumbing vent pipe to provide an auxiliary vent passage from a location below the open top end of the vent pipe to an exterior of the vent pipe.

### BACKGROUND

In a typical plumbing system in a building, a vent pipe is typically connected to the main plumbing stack to be vented through an open top end to the exterior of the building. The open top end of the vent pipe communicates through the roof of the building substantially at or above the upper surface of the roof. In colder climates, warm and humid sewer gases rising up through the vent pipe are known to condense and cause a buildup of frost at the open top end of the vent pipe. In the instance of a full blockage of the vent pipe due to frost, the plumbing system is unable to function properly which can result in sewer gases leaking internally into the building. If the sewer gases displaced too much breathing air within the building, health of the occupants of the building can be seriously affected.

U.S. Pat. No. 3,403,809 by Kennedy et al. discloses an example of a hooded vent cap for mounting on the open top end of a plumbing vent pipe. Although the vent cap prevents debris from entering the vent pipe, the numerous small passages communicating through the vent cap remain problematic for the accumulation of frost thereon in colder climates.

U.S. Pat. No. 4,442,643 by Stadheim discloses an insulated sleeve for surrounding a protruding portion of a plumbing vent pipe, however, the open top end of the vent pipe remains substantially unaltered and exposed to cold temperatures such that the insulated sleeve merely relocates a potential frost blockage to a position spaced above the roof instead of at the roof line where the vent pipe normally terminates.

U.S. Pat. No. 7,655,883 and 2007/0207718, both by Heise, disclose two examples of vent caps for a plumbing vent pipe which is specifically heated to prevent buildup of frost thereon. Heating of the vent cap requires costly and complex electrical circuits to be connected to the building which is impractical in the instance of many building vent pipes.

### SUMMARY OF THE INVENTION

According to one aspect of the invention there is provided a blockage prevention device for a vent pipe of a plumbing system having an open top end which is externally vented, the device comprising:

a venting tube which is elongate in an axial direction, which has a hollow passage therein extending axially between a top end and a bottom end of the venting tube, and which has an outer diameter which is less than an inner diameter of the vent pipe; and

a suspension element fixed to the venting tube having an overall width perpendicular to the axial direction of the venting tube which is greater than the inner diameter of the vent pipe;

the suspension element being spaced above the bottom end of the venting tube such that when the suspension element is engaged upon the top end of the vent pipe: i) the bottom end of the venting tube is arranged to be suspended within the vent pipe in open communication with the vent pipe, and ii) the top end of the venting tube is arranged to communicate externally of the vent pipe.

According to a second aspect of the present invention there is provided a method of preventing blockage of a vent pipe of a plumbing system having an open top end which is externally vented, the method comprising:

providing a venting tube that is elongate in an axial direction, that has a hollow passage therein extending axially between a top end and a bottom end of the venting tube, and that has an outer diameter which is less than an inner diameter of the vent pipe; and

suspending the bottom end of the venting tube within the vent pipe such that the bottom end is in open communication with vent pipe and the top end of the venting tube communicates externally of the vent pipe.

The blockage prevention device according to the present invention is easy to install by simply inserting the device downwardly through the open top end of a vent pipe. No electricity is required to provide heating, but rather the auxiliary passage provided by the hollow tube of the blockage prevention device allows warm sewer gas to escape upwardly through the hollow tube to provide sufficient heat to maintain a flow path and thereby resist complete blockage of the plumbing vent pipe. By forming the hollow tube of a conductive material, the blockage prevention device can be further arranged to conduct heat from the bottom end of the hollow tube at a location which is inside the insulated envelope of the building to the top end of the hollow tube which communicates to the exterior of the building through the open top end of the vent pipe. This conduction of heat along the hollow tube further ensures that a passage is maintained through the open top end of the vent pipe to maintain proper operation of the building plumbing system throughout the cold season.

The suspension element may be fixed to the venting tube at the top end of the venting tube. The suspension element may comprise a crossbar mounted perpendicularly to the axial direction across the top end of the venting tube to protrude from the venting tube in two diametrically opposed directions.

The top end of the venting tube may be vented externally through the suspension element such that the top end of the venting tube is vented externally in two diametrically opposed directions relative to the axial direction of the venting tube.

Preferably the venting tube is formed of heat conductive material.

An outer diameter of the venting tube is preferably less than half an inner diameter of the vent pipe.

The venting tube may include an upper portion in proximity to the top end of the venting tube having a first diameter and a lower portion extending axially between the upper portion and the bottom end of the venting tube having a second diameter which is greater than the first diameter.

The device preferably also includes a centering element supported on the venting tube at a location spaced below the suspension element in which the centering element has an overall width perpendicular to the axial direction which is greater than a diameter of the venting tube and less than a diameter of the vent pipe. The centering element may comprise a crossbar fixedly mounted to the venting tube, transversely to the axial direction.

### BRIEF DESCRIPTION OF THE DRAWINGS

One embodiment of the invention will now be described in conjunction with the accompanying drawings in which:

FIG. 1 is side elevational view of the blockage prevention device;

FIG. 2 is a side elevational view of the blockage prevention device supported within a vent pipe of a plumbing system;

FIG. 3 is a top plan view of the blockage prevention device supported within the vent pipe of the plumbing system according to FIG. 2;

FIG. 4 is a sectional view of a top end of the blockage prevention device along the line 4-4 of FIG. 3;

FIG. 5 is a sectional view of the blockage prevention device along the line 5-5 of FIG. 1; and

FIG. 6 is a sectional view of the blockage prevention device along the line 6-6 of FIG. 1.

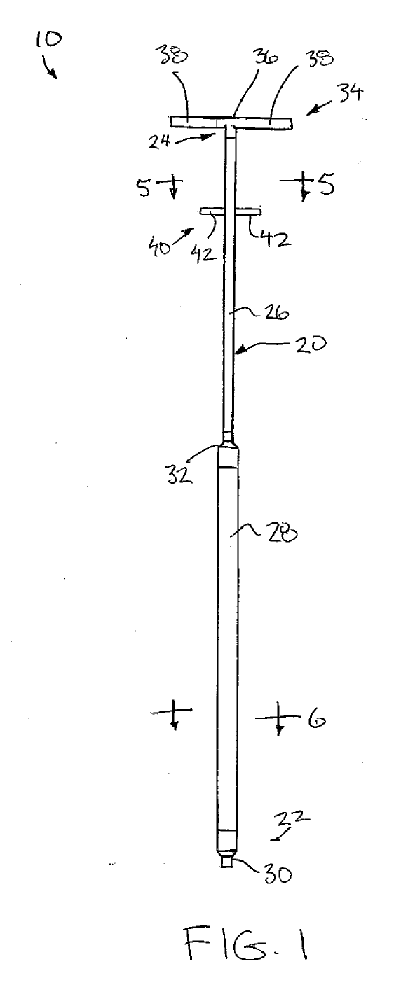

In the drawings like characters of reference indicate corresponding parts in the different figures.

### DETAILED DESCRIPTION

Referring to the coming figures there is illustrated a plumbing vent pipe blockage prevention device generally indicated by reference numeral 10. The device 10 is particularly suited for use with a plumbing system comprising a stack vent pipe 12 which communicates upwardly through the roof 14 of a building to terminate at an open top end which is substantially at or above the upper surface of the roof. The vent pipe 12 typically has a diameter in the range of 3 to 4 inches.

The device 10 generally comprises a venting tube 20 in the form of a rigid hollow member which is elongate in an axial direction between an open bottom end 22 and an open top end 24. The venting tube 20 includes an upper portion 26 terminating at the top and 24 of the venting tube, and a lower portion 28 extending between the upper portion 26 and the bottom end 22 of the tube.

The lower portion 28 of the venting tube defines a first diameter which is substantially less than the inner diameter of the vent pipe. The lower portion 28 comprises a copper pipe having a 1 inch diameter along the full length of the lower portion.

A bottom pipe reducer 30 is mounted at the bottom end in which the diameter of the tube is reduced from the 1 inch diameter of the lower portion to a reduced ½ inch diameter at the open bottom end of the venting tube.

A top pipe reducer 32 is mounted in series between the top end of the lower portion and the bottom end of the upper portion of the venting tube. The diameter of the passage is similarly reduced from the 1 inch diameter of the lower portion to a reduced ½ inch diameter.

The upper portion 26 of the venting tube defines a second diameter of ½ inch along the full length thereof between the top pipe reducer 32 at the bottom end thereof and the top end of the venting tube. The length in the axial direction of the upper portion is less than the length in the axial direction of the lower portion such that the lower portion spans slightly more than half the overall length of the device while the upper portion spans slightly less than half the overall length of the device. In the illustrated embodiment, the overall length is approximately 37 inches, the length of the lower portion is approximately 21 inches, and the length of the upper portion is approximately 16 inches; however, the specific dimensions can vary considerable while still being effective at preventing frost blockage of a vent pipe depending upon the configuration of the vent pipe relative to the building and the climate conditions.

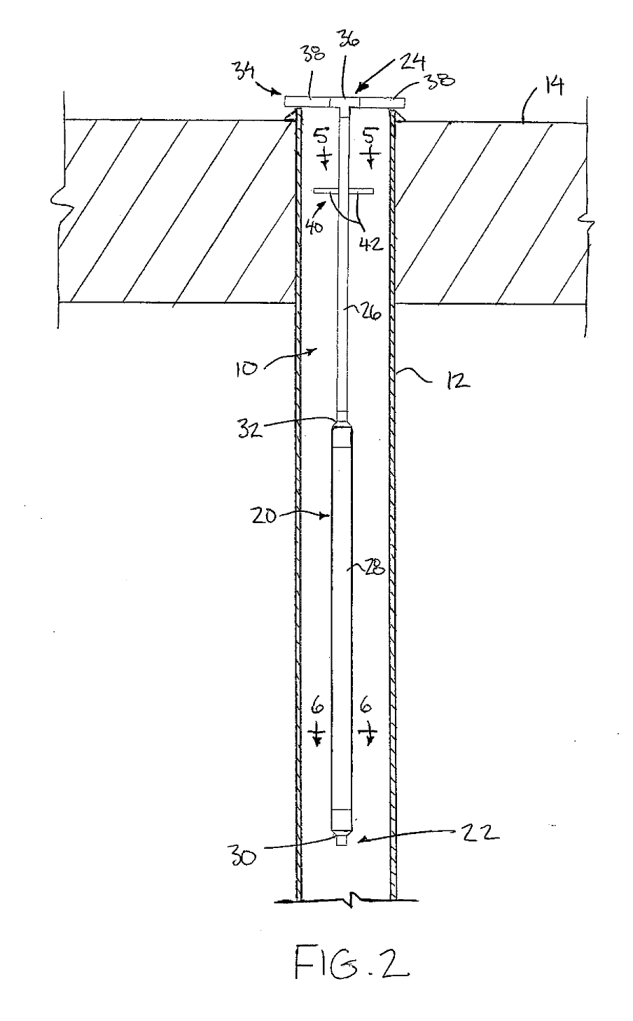

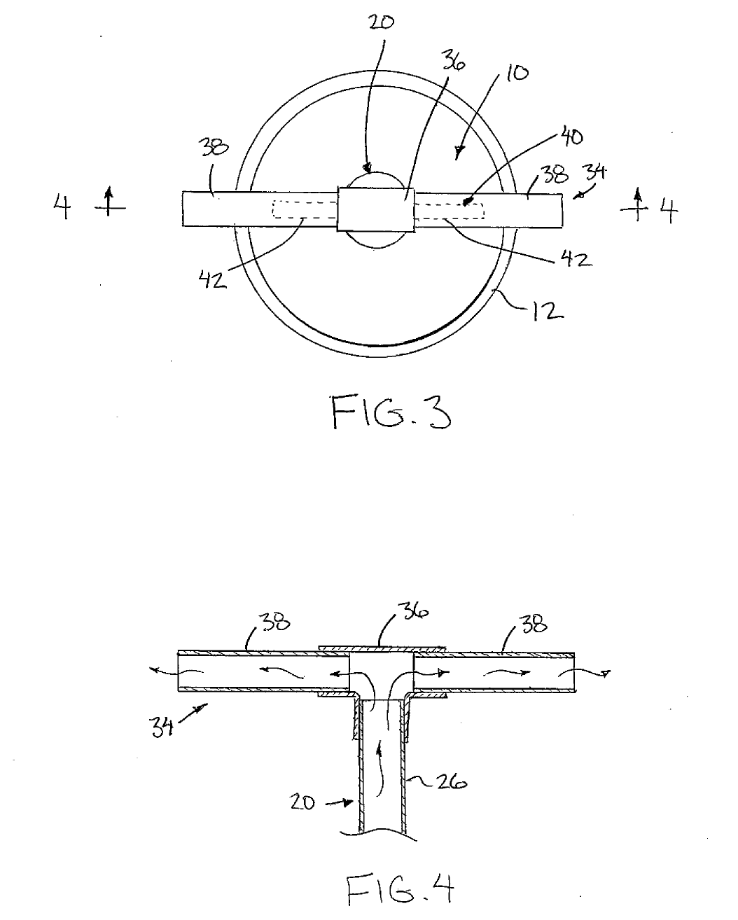

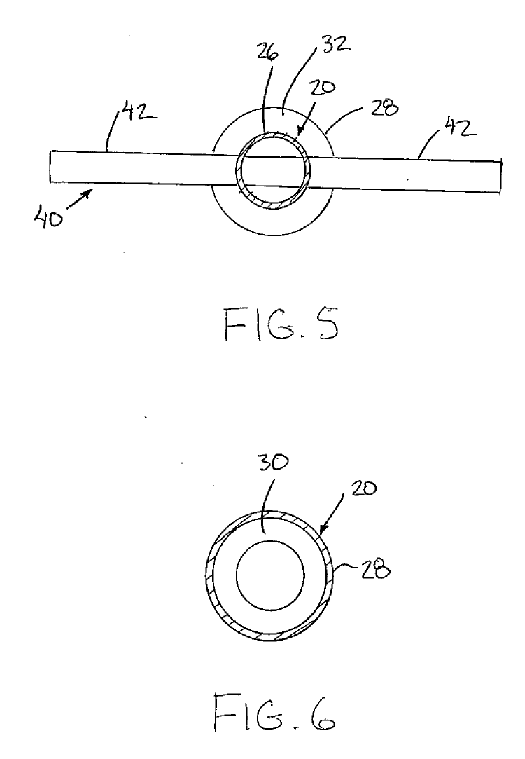

The device 10 further includes a suspension element 34 supported at the top end of the venting tube which defines an overall width perpendicular to the axial direction of the tube which is substantially greater than the diameter of the vent pipe. In this manner the suspension element 34 is arranged to be engaged upon the top end of the vent pipe with the venting tube suspended therefrom within the interior of the vent pipe as shown in FIG. 2.

The suspension element 34 comprises a T-shaped junction 36 connected to the top end of the venting tube and two arms 38 extending laterally outward, perpendicularly to the tube in diametrically opposing directions from the junction 36. The two arms 38 each comprise a hollow pipe, for example a copper pipe having a ½ inch diameter which communicates at an inner end openly with the top end of the venting tube through the junction 36 and which remains open at the outer end. In this manner the top end of the venting tube is vented externally through the junction 36 and the two arms 38 to the diametrically opposed open outer ends of the two arms. Each arm is longer than a radius of the vent pipe to define the overall lateral width which is approximately 6 inches in the preferred embodiment.

The device 10 further includes a centering element 40 in the form of a crossbar tube which is mounted perpendicularly to the axial direction of the venting tube at an intermediate location along the upper portion 26 of the venting tube. The centering element 40 is thus spaced below the top end of the venting tube and spaced above the bottom end of the venting tube, while being closer to the top end than the bottom end. The crossbar tube of the centering element 40 has a smaller diameter than the venting tube, for example an outer diameter of ⅛ of an inch when the diameter of the venting tube is % of an inch. To mount the centering element, a corresponding sized bore is drilled perpendicularly through diametrically opposing sides of the upper portion 26 of the venting tube to slidably receive the centering element therethrough such that the tube of the centering element protrudes equally from both sides of the venting tube. Solder is used to fix the centering element relative to the venting tube.

Once mounted, the crossbar tube of the centering element 40 similarly comprises two arms 42 protruding outwardly from the venting tube at diametrically opposed locations. The length of each arm is less than the radius of the vent pipe such that the overall width perpendicular to the axial direction of the vent pipe is substantially less than the internal diameter of the vent pipe. In the illustrated embodiment the overall width of the centering element is approximately 2½ inches. The centering element 40 merely serves to assist in locating the vent tube near the central axis of the vent pipe in a mounted position such that the venting tube is substantially at or near to being coaxial with the vent pipe in the preferred embodiment.

The entirety of the device 10 in the preferred embodiment is formed of heat conductive copper, including the upper and lower portions of the venting tube, the pipe reducers, the junction 36, the two arms 38 of the suspension element 34, and the two arms 42 of the centering element 40. In this manner, the device 10 is well suited for conducting heat from an interior of the plumbing vent pipe at a location proximate the bottom end of the device 10 which is typically spaced well inside of the insulated boundary of the building. The heat is conducted along the length of the device 10 to the suspension element at the top end of the venting tube through which the venting tube is externally vented at the exterior of the building above the open top end of the vent pipe.

Installation of the device 10 merely involves downward insertion of the bottom end of the venting tube through the open top end of the plumbing vent pipe until the suspension element engages the upper rim of the vent pipe. The dimensions of the centering element 40 are such that the centering element can be readily inserted downwardly into the vent pipe through the open top end of the vent pipe to assist in locating the venting tube spaced inwardly away from any of the interior surfaces of the plumbing vent pipe. The device 10 is typically intended to be simply left in place within the plumbing vent pipe throughout the cold season to provide passive heating to the open top end of the vent pipe by means of an auxiliary passage through the device 10 which permits continued passage of warm sewer gas upwardly therethrough in addition to conducting heat from the bottom end of the device 10 to the top end thereof at the top end of the vent pipe.

Since various modifications can be made in my invention as herein above described, and many apparently widely different embodiments of same made, it is intended that all matter contained in the accompanying specification shall be interpreted as illustrative only and not in a limiting sense.

1. A blockage prevention device for a vent pipe of a plumbing system having an open top end which is externally vented, the device comprising:
a venting tube which is elongate in an axial direction, which has a hollow passage therein extending axially between a top end and a bottom end of the venting tube, and which has an outer diameter which is less than an inner diameter of the vent pipe; and
a suspension element fixed to the venting tube having an overall width perpendicular to the axial direction of the venting tube which is greater than the inner diameter of the vent pipe;
the suspension element being spaced above the bottom end of the venting tube such that when the suspension element is engaged upon the top end of the vent pipe: i) the bottom end of the venting tube is arranged to be suspended within the vent pipe in open communication with the vent pipe, and ii) the top end of the venting tube is arranged to communicate externally of the vent pipe.

2. The device according to claim 1 wherein the suspension element is fixed to the venting tube at the top end of the venting tube.

3. The device according to claim 1 wherein the suspension element comprises a crossbar mounted transversely to the axial direction of the venting tube to protrude from the venting tube in two diametrically opposed directions.

4. The device according to claim 1 wherein the suspension element comprises a crossbar mounted perpendicularly across the top end of the venting tube.

5. The device according to claim 1 wherein the top end of the venting tube is vented externally in two diametrically opposed directions relative to the axial direction of the venting tube.

6. The device according to claim 1 wherein the top end of the venting tube is vented externally through the suspension element.

7. The device according to claim 1 wherein the venting tube is formed of heat conductive material.

8. The device according to claim 1 wherein an outer diameter of the venting tube is less than half an inner diameter of the vent pipe.

9. The device according to claim 1 wherein the venting tube includes an upper portion in proximity to the top end of the venting tube having a first diameter and a lower portion extending axially between the upper portion and the bottom end of the venting tube having a second diameter which is greater than the first diameter.

10. The device according to claim 1 further comprising a centering element supported on the venting tube at a location spaced below the suspension element, the centering element having an overall width perpendicular to the axial direction which is greater than a diameter of the venting tube and less than a diameter of the vent pipe.

11. The device according to claim 10 wherein the centering element comprises a crossbar fixedly mounted to the venting tube, transversely to the axial direction.

12. A method of preventing blockage of a vent pipe of a plumbing system having an open top end which is externally vented, the method comprising:
providing a venting tube that is elongate in an axial direction, that has a hollow passage therein extending axially between a top end and a bottom end of the venting tube, and that has an outer diameter which is less than an inner diameter of the vent pipe; and
suspending the bottom end of the venting tube within the vent pipe such that the bottom end is in open communication with vent pipe and the top end of the venting tube communicates externally of the vent pipe.

13. The method according to claim 12 including supporting a bottom end of the venting tube in the vent pipe of a building at a location which is spaced internally relative to an insulating boundary of the building.

14. The method according to claim 12 including suspending the venting tube from a suspension element supported on an upper rim of the vent pipe and venting the top end of the venting tube externally through the suspension element.
